(19) United States
(12) Patent Application Publication
(10) Pub. No.: US 2011/0149039 A1
(43) Pub. Date: Jun. 23, 2011

(54) DEVICE AND METHOD FOR PRODUCING NEW 3-D VIDEO REPRESENTATION FROM 2-D VIDEO

(75) Inventors: Jae Hwan KIM, Daejeon (KR); Jae Hean Kim, Yongin-si (KR); Jin Ho Kim, Daejeon (KR); Il Kwon Jeong, Daejeon (KR)

(73) Assignee: Electronics and Telecommunications Research Institute, Daejeon (KR)

(21) Appl. No.: 12/970,089

(22) Filed: Dec. 16, 2010

(30) Foreign Application Priority Data
Dec. 18, 2009 (KR) 10-2009-0127352
Mar. 30, 2010 (KR) 10-2010-0028570

(51) Int. Cl. H04N 13/00

(52) U.S. Cl. 348/44; 348/E13.003

(57) ABSTRACT

The present invention relates to a device and a method for allowing a user to reproduce new 3-D scene from one or two or more given 2-D video frames that already exist. The present invention provides a device and a method for automating post-image processing requiring a lot of manual work, thereby making it possible to produce and edit new 3-D representation from the existing 2-D video.

### CROSS-REFERENCE TO RELATED APPLICATIONS

This application claims priority under 35 U.S.C. §119 to Korean Patent Application No. 10-2009-0127352, filed on Dec. 18, 2009 and No. 10-2010-0028570, filed on Mar. 30, 2010, in the Korean Intellectual Property Office, the disclosure of which is incorporated herein by reference in its entirety.

### BACKGROUND OF THE INVENTION

1. Field of the Invention

The present invention relates to a device and a method for producing new 3-D video representation from 2-D video, and more particularly, to a device and a method for new 3-D video representation from 2-D video capable of producing and editing new 3-D video representation using automatic tracking matte, depth value generation, and stored 3-D image.

2. Description of the Related Art

In order to generate computer-generated imagery such as video special effects, specific contours in a video should be tracked and a specific matte or filter should be applied to the tracked contours. A process of tracking the specific contours is generally performed manually. In addition, a device for matting the tracked contours can be applied to only still images. However, this is made through collective color correction in an image sequence, such that there are disadvantages in that noise is generated and it is difficult to perform partial specific contours.

Recently, a research for recovering a 2-D image to a 3-D image based on a computer vision technology has been largely conducted. However, this research recovers the contours in the given image sequence and is limited to static contours as a target. Therefore, manual work is still needed to recover and visualize the 3-D video representation.

### SUMMARY OF THE INVENTION

Therefore, it is an object of the present invention to provide a device and a method for automatically tracking specific regions of each frame based on a keyframe and a device and a method for matting images using the tracked specific regions and a trimap in order to produce and edit new 3-D video representation using the existing 2-D video. In addition, it is another object of the present invention to provide a device and a method for automatically generating depth values of each frame. Further, it is still another object of the present invention to provide a device and a method capable of producing and editing new 3-D video representation using a stored 3-D image.

In order to achieve the above-mentioned objects, according to an aspect of the present invention, there is provided an automatic tracking matting module, including: an input unit that receives frames, keyframes, and trimaps of a 2-D image; a tracking unit that tracks specific regions for each frame based on the keyframes; and a matting unit that mattes each frame by using the tracked specific regions for each frame and the trimaps.

Preferably, the automatic tracking matting module further includes a display unit that displays matting results of each frame.

According to an another aspect of the present invention, there is provided a device for producing 3-D video representation, including: a receiver that receives 2-D video frames; a keyframe generator that generates keyframes in the frames; and a 3-D image generator that generates a 3-D image from the keyframes; wherein the keyframe generator includes: a pixel definition module that defines pixels by adding a depth value channel to a color value channel and an alpha value channel of the frame; a layer definition module that defines a layer by adding a camera reference channel representing 3-D coordinate values to the pixel definition module; and a keyframe definition module that defines the keyframes by adding contours to be tracked among the 2-D images to the layer definition module.

Preferably, the keyframe is defined to further include: a regression function that calculates the depth value of the frame; and a frame range that represents an applicable range of the regression function.

The 3-D image generator is the automatic tracking matting module according to claim 1 or 2.

The 3-D image generator is the depth value generating module including: a control unit that determines whether the frame belongs to the keyframe range; and a function unit that inputs the velocity and coordinate values of the frame to the regression function of the keyframe to extract the depth value.

The depth value generating module further includes a mesh map generation unit that generates an irregular mesh map based on a color-based grouped region, wherein the receiver uses the mesh map to further receive a local depth value set by the user.

The device for producing 3-D video representation further includes an authoring tool that completes the 3-D image.

The device for producing 3-D video representation further includes a storage that stores the 3-D image.

The device for producing 3-D video representation further includes a 3-D video representation generator that produces new 3-D video representation using the 3-D image stored in the storage.

According to an another aspect of the present invention, there is provided an automatic tracking matting method, including: receiving frames, keyframes, and trimaps of a 2-D image; tracking specific regions for each frame based on the keyframes; and matting each frame by using the tracked specific regions for each frame and the trimaps.

Preferably, the automatic tracking matting method further includes displaying matting results of each frame; and determining whether a corrected alpha map is received.

According to an another aspect of the present invention, there is provided a method for producing 3-D video representation, including: (a) receiving 2-D video frames; (b) generating keyframes in the frames; and (c) generating 3-D image from the keyframes; wherein the (b) includes: (b-1) defining pixels by adding a depth value channel to a color value channel and an alpha value channel of the frame; (b-2) defining a layer by adding a camera reference channel representing 3-D coordinate values to the pixel definition module; and (b-3) defining the keyframes by adding contours to be tracked among the 2-D images to the layer definition module.

Preferably, the (b) further includes: defining a regression function that calculates the depth value of the frame; and defining a frame range that represents an applicable range of the regression function.

The (c) is the automatic tracking matting method according to claim 1 or 2.

The (c) includes: receiving the keyframe and the frame of the 2-D image; determining whether the frame belongs to the keyframe range; extracting the velocity and coordinate values from the frame; extracting the depth value by inputting the velocity and coordinate values to the regression function of the keyframe; and setting the depth value in the frame.

The method for producing 3-D video representation further includes: generating an irregular mesh map based on a grouped region in the 2-D image; and receiving a local depth value set by the user by using the mesh value.

The method for producing 3-D video representation further includes completing 3-D image.

The method for producing 3-D video representation further includes the 3-D image.

The method for producing 3-D video representation further includes producing new 3-D video representation using the stored 3-D image.

According to an exemplary embodiment of the present invention, it automatically tracks and separates the contours in the images and automatically generates and stores the depth values, thereby making it possible to edit and produce the user desired new 3-D video representation from the 2-D video.

### BRIEF DESCRIPTION OF THE DRAWINGS

FIG. 1 is an overall configuration diagram showing a device for producing new 3-D video representation from 2-D video;

FIG. 2 is a configuration diagram showing keyframe generation for producing new 3-D video representation;

FIG. 3 is a configuration diagram showing an automatic tracking matting module for generating a 3-D image from a 2-D image;

FIG. 4 is a configuration diagram showing a depth value generating module for generating the 3-D image from the 2-D image;

FIG. 5 is a block diagram showing a method for producing new 3-D video representation from 2-D video;

FIG. 6 is a block diagram showing an automatic tracking matting method for generating the 3-D image from the 2-D image; and

FIG. 7 is a block diagram showing a depth value generating method for generating the 3-D image from the 2-D image.

### DETAILED DESCRIPTION OF THE PREFERRED EMBODIMENTS

Advantages and features of the present invention and methods to achieve them will be elucidated from exemplary embodiments described below in detail with reference to the accompanying drawings. However, the present invention is not limited to exemplary embodiment disclosed herein but will be implemented in various forms. The exemplary embodiments is provided by way of example only so that a person of ordinary skilled in the art to fully understand the disclosures of the present invention and the scope of the present invention. Therefore, the present invention will be defined only by the scope of the appended claims. Meanwhile, terms used in the present invention are to explain the exemplary embodiments rather than limiting the present invention. Unless explicitly described to the contrary, a singular form includes a plural form in the present specification. “Comprises” and/or “comprising” used herein does not exclude the existence or addition of one or more other components steps, operations, and elements in addition to the above-mentioned components, operations, and/or elements. In addition, the detailed description of a related known function or configuration that may make the purpose of the present invention unnecessarily ambiguous in describing the present invention will be omitted.

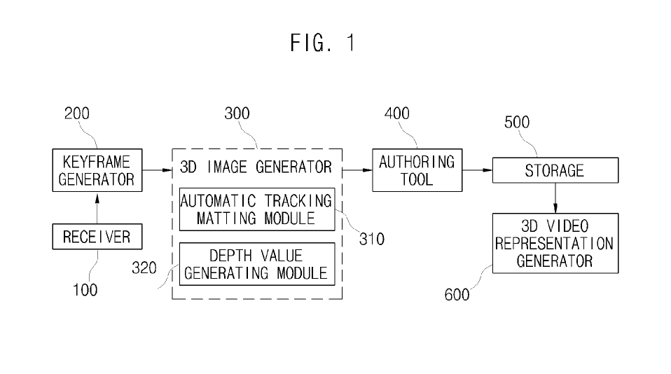

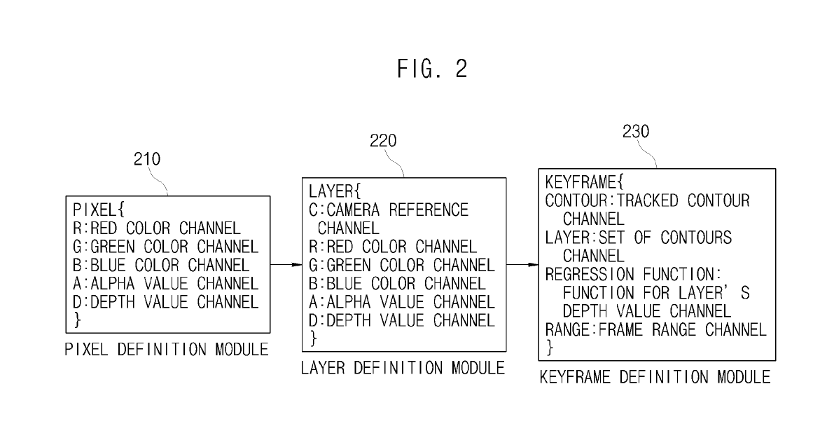

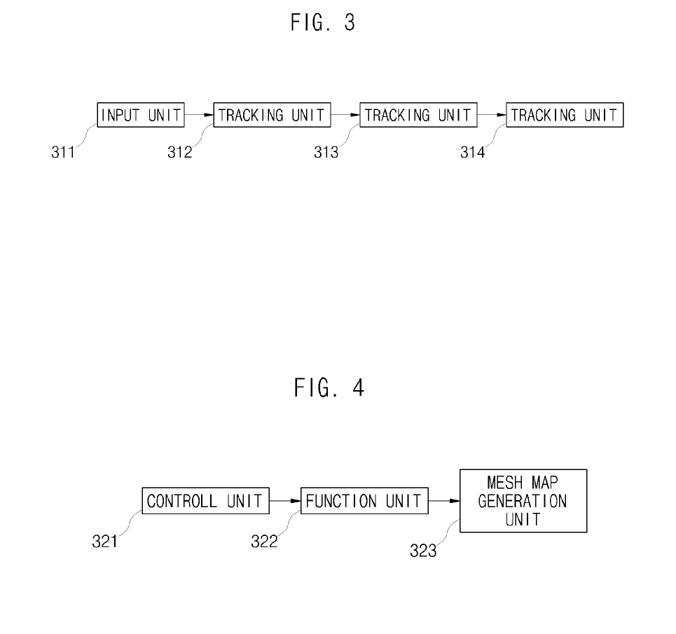

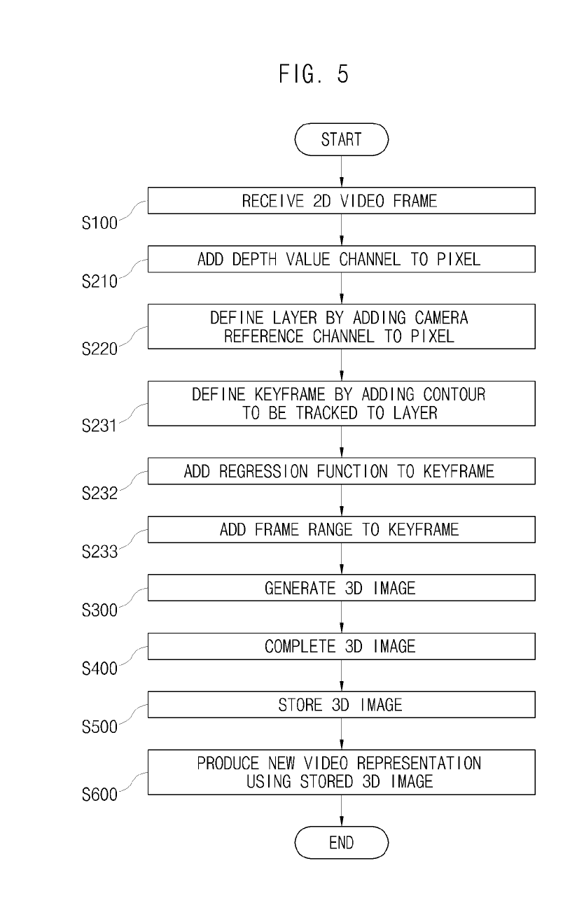

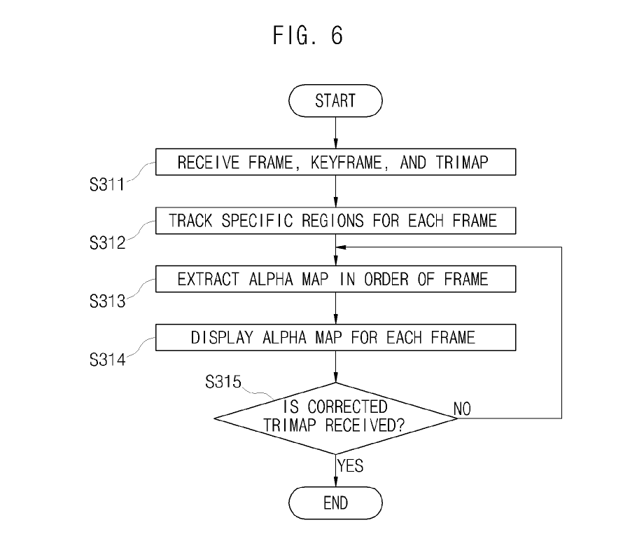

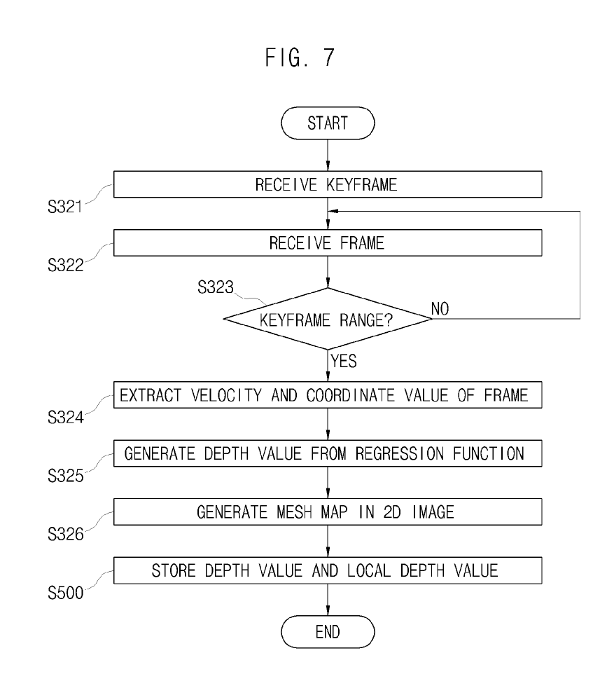

FIG. 1 is an overall configuration diagram showing a device for producing new 3-D video representation from 2-D video, FIG. 2 is a configuration diagram showing keyframe generation for producing new 3-D video representation, FIG. 3 is a configuration diagram showing an automatic tracking matting module for generating a 3-D image from a 2-D image, and FIG. 4 is a configuration diagram showing a depth value generating module for generating the 3-D image from the 2-D image. FIG. 5 is a block diagram showing a method for producing new 3-D video representation from 2-D video, FIG. 6 is a block diagram showing an automatic tracking matting method for generating the 3-D image from the 2-D image, and FIG. 7 is a block diagram showing a depth value generating method for generating the 3-D image from the 2-D image.

The present invention requires auto-rotoscoping that generates keyframe generation and tracking from a 2-D video frame, matting about tracked contours, depth value generation for the contours, an image completion technology of holes or occlusion portion of the contours, and a database that can store and select each contour, in order to produce new 3-D video representation from one or two or more 2-D image.

Referring to FIG. 1, a device for producing 3-D video representation from 2-D video according to the present invention includes a receiver 100, a keyframe generator 200, a 3-D image generator 300, an authoring tool 400, a storage 500, and a 3-D video representation generator 600.

The receiver 100 receives one or two or more 2-D video frames.

The keyframe generator 200 produces keyframes from the 2-D video frames. The detailed description of the keyframe generator 200 will be described below.

The 3-D image generator 300 produces a 3-D image for producing and editing the 3-D video representation based on the keyframes. According to the present invention, the 3-D image generator 300 may include an automatic tracking matting module 310 and a depth value generating module 320. The automatic tracking matting module 310 and the depth value generating module 320 will be described below.

The authoring tool 400 aids that the user can perform the 3-D image completion produced from the 3-D image generator 300. There may occur holes or occlusion in the 3-D image generated in the 3-D image generator 300. The authoring tool 400 may serve to naturally complete the holes or occlusions, etc., existing in the video by using adjacent pixel values or information on the previous/later frames of the corresponding video.

The storage 500 stores the 3-D image including the matting results by the automatic tracking matting module 310 and the information on the depth values and the local depth values by the depth value generating module 320 in the database. Further, the storage 500 stores the 3-D image completed in the authoring tool 400 and provides the completed 3-D image to the 3-D video representation generator 600

The 3-D video representation generator 600 may serve to produce and edit new 3-D video representation from the existing 2-D video by rearranging the contours according to a criteria that can allow the user to represent the image as the 3-D image. As the method for representing the 3-D image, there may be a stereoscopic based method that produces video using a fact that a human being feels a 3-D effect due to the difference between images formed on his/her own left and right eyes, an image based rendering method for multi-view, and a hologram.

As described above, the present invention can produce and edit the new 3-D video representation using the existing 2-D video. Therefore, the present invention is effective in that the new 3-D video representation is produced by reusing the existing video. Further, the automatic tracking matting module 310 or the depth value generating module 320 may be applied to various fields.

Referring to FIG. 2, the keyframe generator 200 for producing the keyframes from the 2-D video frames according to the present invention includes a pixel definition module 210, a hierarchical definition unit 220, and a keyframe definition module 230. The pixel definition module 210 defines pixels by adding a depth value channel to a red color channel, a green color channel, and a blue color channel and an alpha value channel indicating transparency. The depth values of each pixel represent a 3-D distance difference between the contours in the video and are represented as values between 0 and 255. The depth value approaches 0 as the contours are close to each other. The depth value is used to generate stereo view and multi-view together with the 2-D image.

The layer definition module 220 defines contours by adding a camera reference channel representing world-to-image projection matrix information on the image to the pixel definition module 210. The world-to-image projection matrix on the image represents (x, y, z) coordinates in a 3-D space and reflects the motion of the contours in the 3-D space. The camera reference channel is used for the 3-D video representation of the multi-view and is used to generate left/right shift video in order to represent the stereoscopic based 3-D image. Further, a velocity value may be extracted from the camera reference channel as described below.

The keyframe definition module 230 defines keyframes by adding contours to be tracked, a regression function for calculating the depth value of the contour to be tracked at each frame, and a frame range indicating the applicable range of the regression function to the layer definition module 220. The information on the regression function and the frame range that are defined in the keyframe is used in the depth value generating module 320 to be described below.

Referring to FIG. 3, the automatic matting device 310 according to the present invention includes an input unit 311, a tracking unit 312, a matting unit 313, and a display unit 314.

The input unit 311 receives one or two or more 2-D video frames, a keyframe, and a trimap. The trimap means a map that represents a foreground, a background, and an intermediate region therebetween.

The tracking unit 312 tracks the specific region for each frame based on the keyframe. The keyframe means a frame specifically representing the specific region to be tracked by the user among the 2-D video frames. In other words, the tracking unit 312 automatically tracks the specific region in the remaining frames other than the keyframe based on the keyframe specifically represented by the user. As the automatic tracking method, there may be an optical flow method, a kernel based mean-shift method using similarity of contour distribution, a contour tracking method based on boundary detection between contours, and so on. Further, the tracking unit 312 sufficiently uses the depth values to smoothly track the specific region even when the occlusion occurs.

The matting unit 313 performs the matting by using the specific region tracked in the tracking unit 312 and the trimap for the tracked specific region. The matting means the case of extracting the alpha map representing transparency by precisely separating the contours that become the foreground and the background. The matting unit 313 may automatically extract the alpha map from the specific region of the tracking unit 312 and the trimap for the specific region by using several algorithms based on machine-learning.

The display unit 314 displays the matting results for each frame of the matting unit, such that the user may detect the errors of the separated foreground and background. The user corrects the trimap and input it again if it is determined that there is the error. The matting unit 313 again extracts the alpha map from the corrected trimap received from the input unit 311 and the specific region of the tracking unit 312 and the display unit 313 displays the results so that the user can detect the error.

Referring to FIG. 4, the depth value generating module 320 includes a control unit 321, a function unit 322, and a mesh map generation unit 323. The depth value generating module 320 generates depth values using the frame and the keyframe. As described above, the keyframe includes the contours to be tracked, the layer, the regression function, and the information on the frame range.

The control unit 321 determines whether the corresponding frame belongs to the frame range of the keyframe. For example, when the frame range of the keyframe is 10 to 20 and the corresponding frame is 15, the corresponding frame belongs to the keyframe range.

The function unit 322 generates the depth values for each frame by using the regression function of the keyframe when the corresponding frame belongs to the keyframe range. The regression function is a mathematical model representing the relationship between independent variables and dependent variables. When any independent variables are given by the mathematical model, the regression function may correspondingly predict the dependent variables. The regression function may be a linear regression function and a non-linear regression function. For example, the linear regression functions may be represented as follows.

Y=β₀+β₁X₁+β₂X₂+ε [Equation 1]

Y represents the dependent variable and X1 and X2 represents the independent variables.

In the present invention, the dependent variable Y represents the depth value and the independent variables X1 and X2 represent the position and velocity of the contour in the frame. In other words, when the position and velocity of the contour are known, the depth value can be automatically calculated. The position of the contour may be extracted from the camera reference channel information of the layer. The velocity may be extracted from the velocity vector value obtained through the automatic tracking when the contour to be tracked is matted by the automatic tracking matting method. In addition, the velocity may be obtained by multiplying the number of frames per second by the positional change between the immediately preceding frame and the current frame. That is, it may be obtained as follows.

Velocity=\sqrt{(x₂−x₁)²+(y₂−y₁)²+(z₂−z₁)²}×number of frames per second [Equation 2]

(x1, y1, z1) represents the position of the object in the immediately preceding frame and (x2, y2 z2) represents the position of the object in the current frame.

In addition to the depth value as described above, a local depth may be set. The local depth value is needed to more delicately represent the video.

The mesh map generation unit 323 generates an irregular mesh map for a color-based grouped region. The above-mentioned mesh map is provided to the user, such that the user may flexibly set the local depth value by setting the number of groups.

The receiver 100 receives the local depth value set by the mesh map used by the user and the storage 500 stores the depth value automatically derived by the function unit and the local depth value of the receiver 100.

As described above, the depth value generating module 320 semi-automatically extracts the depth value of the object based on the keyframe and generates the mesh map and provides it to the user, thereby making it possible to set the local depth value for finely representing the video. Therefore, it can obtain an effect that can generate the 3-D image by sufficiently reflecting the correlation between respective frames.

The method for producing 3-D video representation from 2-D video according to the present invention will be described with reference to FIG. 5. The receiver receives the 2-D video frame (S100).

Next, the pixel definition module 210 adds the depth value channel to the pixel including the R, G, B color values and the alpha value for transparency (S210). The depth values of each pixel represent a 3-D distance difference between the objects in the video and are represented as values between 0 and 255. The depth value approaches 0 as the objects are close to each other. The depth value is used to generate stereo view and multi-view together with the 2-D image.

Next, the layer definition module 220 adds the camera reference channel representing the 3-D coordinate values to the pixel including the depth value (S220). The camera reference channel represents (x, y, z) coordinates in a 3-D space and reflects the motion of the objects in the 3-D space. The camera reference channel may be used to represent the 3-D video representation of the multi-view and the stereoscopic-based 3-D video representation.

Next, the keyframe definition module 230 defines the keyframe by adding the contour to be tracked to the layer (S231).

Next, the keyframe definition module 230 adds the regression function (S232) and the frame range to the keyframe (S233). The keyframe regression function is to automatically generate the depth values for each frame and the frame range defines the frame values to which the keyframe regression function is applicable.

Next, the 3-D video generator 300 generates the 3-D image based on the keyframe (S300). The 3-D image is used to produce the new 3-D video representation. As the 3-D image generating method, the present invention may use the automatic tracking matting method and the depth value generating method.

Next, the authoring tool 400 performs a function when the user can complete the 3-D image produced from the 3-D image generator 300 (S400). The holes may occur in the 3-D image generated in the 3-D image generator 300. The authoring tool 400 may serve to complete the holes, etc., by using adjacent pixel values or information on the previous/later frames of the corresponding video

Next, the storage 500 stores the alpha value extracted by the automatic tracking matting method and the depth value and the local depth value by the depth value generating method (S500). In addition, the completed 3-D image is stored in the database.

Next, the 3-D video representation generator 600 may serve to produce and edit the new 3-D video representation from the existing 2-D video by rearranging the contours according to a reference that can allow the user to represent the video as the 3-D image (S600). As the method for representing the 3-D image, there may be a stereoscopic based method that produces video using a fact that a human being feels a 3-D effect due to the difference between images formed on his/her own left and right eyes, an image based rendering method for multi-view, and a hologram.

The automatic tracking matting method according to the present invention will be described with reference to FIG. 6. The receiver 100 receives the frame, keyframe, and trimap of the 2-D image (S311).

Next, the automatic tracking matting module 310 tracks the specific regions for each frame based on the keyframe (S312). The keyframe means two or more frames specifically displaying the specific region to be tracked by the user among the 2-D video frames. In other words, the automatic tracking matting module 310 automatically tracks the specific region in the remaining frames other than the keyframe based on the keyframe specifically represented by the user.

Next, the automatic tracking matting module 310 extracts the alpha map representing transparency by precisely separating the contours that become the foreground and the background by using the tracked specific region and the trimap for the specific region (S313). In other words, the automatic tracking matting module 310 automatically extracts the alpha map from the tracked specific region and the trimap for the specific region by using several algorithms based on machine-learning

Next, the automatic tracking matting module 310 displays the matting results for each frame (S314). The user checks whether there is a partial error for the foreground and the background separated as the displayed matting results. The user corrects the previously defined trimap for the specific region and inputs it again if it is determined that there is the error.

Next, the automatic tracking matting module 310 determines whether it receives the corrected trimap (S315). When there is the corrected trimap, it extracts the new alpha map from the corrected trimap and the tracked specific region and displays the results. The user checks whether there is an error in the new alpha map.

The method for generating the depth value according to the present invention will be described with reference to FIG. 7. First, the receiver 100 receives the keyframe (S321). The keyframe includes the contours to be tracked, the regression function, and the information on the frame range.

Next, the receiver 100 receives the frame that is a target of the depth value generation (S322).

Next, the depth value generating module 320 determines whether the frame belongs to the frame range of the keyframe (S323). For example, when the frame range is 10 to 20 and the corresponding frame is 15, the corresponding frame belongs to the range of the keyframe.

Next, the depth value generating module 320 extracts the velocity and position values of the corresponding frame (S324). The position value may be extracted from the camera reference channel information of the layer. The velocity may be extracted from the velocity vector value obtained through the automatic tracking when the contour to be tracked is matted by the automatic tracking matting method. In addition, the velocity may be extracted by multiplying the positional change between the frames by the number of frames per second. The detailed description thereof was already described above.

Next, the depth value generating module 320 inputs the extracted position and velocity to the regression function to generate the depth value (S325). The regression function is a mathematical model representing the relationship between independent variables and dependent variables. When any independent variables are given by the mathematical model, the regression function may correspondingly predict the dependent variables. In the present invention, when the position and velocity are input to the regression function as the independent variables, the dependent variable, that is, the depth value is generated. The detailed description thereof was already described above.

Next, the depth value generating module 320 generates the irregular mesh map for the color-based grouped region (S326). The generated mesh map is provided to the user, such that the user may flexibly set the local depth value by setting the number of groups. The local depth value can more finely represent the video.

Next, the depth value generating module 320 stores the depth value derived by the regression function (S500). In addition, it allows the user to store the local depth value set by using the mesh map.

Although preferred embodiments of the present invention have been illustrated and described, the present invention is not limited to the above-mentioned embodiments and various modifications can be made by those skilled in the art without the scope of the appended claims of the present invention. In addition, these modified embodiments should not be appreciated separately from technical spirits or prospects.

What is claimed is:

1. An automatic tracking matting module, comprising:
an input unit that receives a frame, keyframe, and trimap of 2-D image;
a tracking unit that tracks a specific region for the frame based on the keyframe; and
a matting unit that matts the frame by using the tracked specific region for the frame and the trimap.

2. The automatic tracking matting module according to claim 1, further comprising a display unit that displays a matting result of the frame.

3. A device for producing 3-D video representation, comprising:
a receiver that receives a 2-D video frame;
a keyframe generator that generates a keyframe in the frames; and
a 3-D image generator that generates a 3-D image from the keyframe;
wherein the keyframe generator includes:
a pixel definition module that defines pixels by adding a depth value channel to a color value channel and an alpha value channel of the frame;
a layer definition module that defines a layer by adding a camera reference channel representing 3-D coordinate values to the pixel definition module; and
a keyframe definition module that defines the keyframe by adding a contour to be tracked among the 2-D video frame to the layer definition module.

4. The device for producing 3-D video representation according to claim 3, wherein the keyframe is defined to further include:
a regression function that calculates the depth value of the frame; and
a frame range that represents an applicable range of the regression function.

5. The device for producing 3-D video representation according to claim 3, wherein the 3-D image generator is the automatic tracking matting module according to claim 1.

6. The device for producing 3-D video representation according to claim 4, wherein the 3-D image generator is the depth value generating module including:
a control unit that determines whether the frame belongs to the frame range of the keyframe; and
a function unit that inputs a velocity and coordinate values of the frame to the regression function of the keyframe to extract the depth value.

7. The device for producing 3-D video representation according to claim 6, wherein the depth value generating module further includes a mesh map generation unit that generates an irregular mesh map based on a color-based grouped region,
wherein the receiver uses the mesh map to further receive a local depth value set by the user.

8. The device for producing 3-D video representation according to claim 3, further comprising an authoring tool that completes the 3-D image.

9. The device for producing 3-D video representation according to claim 3, further comprising a storage that stores the 3-D image.

10. The device for producing 3-D video representation according to claim 9, further comprising a 3-D video representation generator that produces a new 3-D video representation using the 3-D image stored in the storage.

11. An automatic tracking matting method, comprising:
receiving a frame, keyframe, and trimap of 2-D image;
tracking a specific region for the frame based on the keyframe; and
matting the frame by using the tracked specific region for the frame and the trimap.

12. The automatic tracking matting method according to claim 11, further comprising:
displaying a matting result of the frame; and
determining whether a corrected alpha map is received.

13. A method for producing 3-D video representation, comprising:
(a) receiving a 2-D video frame;
(b) generating a keyframe in the frame; and
(c) generating a 3-D image from the keyframe;
wherein the (b) includes:
(b-1) defining pixels by adding a depth value channel to a color value channel and an alpha value channel of the frame;
(b-2) defining a layer by adding a camera reference channel representing 3-D coordinate values to the pixels; and
(b-3) defining the keyframe by adding a contour to be tracked among the 2-D video frame to the layer.

14. The method for producing 3-D video representation according to claim 13, wherein the (b) further includes:
defining a regression function that calculates the depth value of the frame; and
defining a frame range that represents an applicable range of the regression function.

15. The method for producing 3-D video representation according to claim 13, wherein the (c) is the automatic tracking matting method according to claim 11.

16. The method for producing 3-D video representation according to claim 14, wherein the (c) includes:
receiving the keyframe and the frame of the 2-D image;
determining whether the frame belongs to the frame range of the keyframe;
extracting a velocity and coordinate values from the frame;
extracting the depth value by inputting the velocity and coordinate values to the regression function of the keyframe; and
setting the depth value in the frame.

17. The method for producing 3-D video representation according to claim 16, further comprising:
generating an irregular mesh map based on a grouped region in the 2-D image; and,
receiving and storing a local depth value set by the user by using the mesh value.

18. The method for producing 3-D video representation according to claim 13, further comprising completing 3-D image.

19. The method for producing 3-D video representation according to claim 13, further comprising storing the 3-D image.

20. The method for producing 3-D video representation according to claim 19, further comprising producing a new 3-D video representation using the stored 3-D image.
